(19) United States
(12) Patent Application Publication
(10) Pub. No.: US 2018/0239646 A1
(43) Pub. Date: Aug. 23, 2018

(54) INFORMATION PROCESSING DEVICE, INFORMATION PROCESSING SYSTEM, TASK PROCESSING METHOD, AND STORAGE MEDIUM FOR STORING PROGRAM

(71) Applicant: NEC Corporation, Minato-ku, Tokyo (JP)

(72) Inventor: Satoshi YAMAKAWA, Tokyo (JP)

(73) Assignee: NEC Corporation, Minato-ku, Tokyo (JP)

(21) Appl. No.: 15/525,123

(22) PCT Filed: Dec. 10, 2015
(86) PCT No.: PCT/JP2015/006167

§ 371 Date: May 8, 2017

(30) Foreign Application Priority Data
Dec. 12, 2014 (JP) 2014-252130

(51) Int. Cl. G06F 9/50; G06F 9/38; G06F 9/455; G06F 9/48

(52) U.S. Cl. CPC G06F 9/5077; G06F 9/3891; G06F 2009/45579; G06F 9/48; G06F 2009/45583; G06F 9/45558

(57) ABSTRACT

In a distributed processing system it is difficult to use resources efficiently without underutilization of resources. In contrast thereto, this information processing device includes: a cluster management means, which is connected to multiple task execution servers that execute tasks by means of one or more virtual machines forming a server virtualization environment, and which manages cluster configuration information indicating the hardware configuration of the task execution servers; a deployment means which, with respect to the multiple task execution servers, mandates the activation of the virtual machines on the basis of a deployment pattern for setting the number of virtual machines included in each of the task execution servers; a job distribution means, which distributes jobs to the virtual machines indicated by the cluster configuration information and activated by the task execution server; and a task execution command means, which transmits tasks that include jobs to the job distribution means, determines a deployment pattern on the basis of supplementary information assigned to the jobs included in each task, and transmits the deployment pattern to the deployment means.

### TECHNICAL FIELD

The present invention relates to an information processing device, an information processing system, a task processing method, and a program, which is capable of processing data in parallel.

### BACKGROUND ART

There have been known a plurality of server nodes and a distributed file system that can be accessed from the server nodes. For executing data analysis for a data group stored in such a distributed file system, there are methods of shortening processing time for the data analysis. These methods divide a data analysis task into a plurality of job groups and distribute the job groups to a plurality of server nodes where the jobs are executed in parallel.

A typical example of these methods is a data analysis method using MapReduce® algorithm of Hadoop®. With this analysis method, a programmer can program a data analysis task without the need of being aware of the structure of the distributed processing system (a node structure, deployment destinations of data, or the like) that performs data analysis. This analysis method enables parallel processing of the task in accordance with the structure of the distributed processing system side only by programming a procedure based on the processing procedure of MapReduce. Such a function can be realized since the parallel distribution mechanism equipped in Hadoop includes a function of autonomously controlling division of a task into a plurality of jobs, distribution of the jobs, and collection of the results in accordance with a system structure.

In addition, another example of the above-described data analysis methods is a method such as the following. This method, in a distributed processing system similar to that of the above method, uses information of the structure of the distributed processing system and resource amounts of central processing units (CPUs), such as, the number of cores, operation frequency, and the number of threads of the CPU of each node. The method further uses information including the input/output (I/O) performance of a storage system used in the distributed file system and the characteristics of tasks to be executed (e.g., CPU dependent, I/O dependent, or the like). The method divides the task of the data analysis processing into a plurality of jobs in accordance with the information. Then, the method determines fixed nodes for execution, for which the task is programmed.

In comparison with cases of using Hadoop, this method increases the complexity of programming and decreases the degree of freedom of the program itself for a change in the system structure. Instead, this method can efficiently utilize given computing resources in accordance with the characteristic of a task when dividing the task into a plurality of jobs and executing the jobs in parallel. This allows further reduction in processing time for executing the task.

PTL 1 discloses a technique of allocating resources to virtual machines in a virtual system environment. Specifically, a computer defines application spaces as spaces for performing applications in a virtual space in a physical machine and allocates resources to the application spaces.

PTL 2 discloses a technique of managing processing tasks by dividing the tasks into CPU dependent (CPU bound) tasks and I/O dependent (I/O bound) tasks and determining the priority order of the processing tasks in accordance with the states of the CPU and I/O (free state/busy state). This can realize improved total throughput.

### CITATION LIST

### Patent Literature

[PTL 1] Japanese Unexamined Patent Application Publication No. 2011-118864

[PTL 2] Japanese Unexamined Patent Application Publication No. Hei 06(1994)-012263

### SUMMARY OF INVENTION

### Technical Problem

If Hadoop is used for processing of dividing a task into a plurality of jobs and executing the jobs in parallel, a computer distributes the jobs evenly to node units constituting a distributed processing system for executing the jobs.

Moreover, when Hadoop is used, the processing is performed on the premise of even distribution of jobs to node units even if the specifications of the hardware (H/W) of the server node group constituting the distributed processing system partially vary. As such, the total processing time of a task relies on the processing time of a job at a node that has the poorest performance, elongating the processing time. Thus, there is a difficulty in the efficient use of resources without underutilization of the resources in the distributed processing system.

To solve such a problem, a computer divides jobs in consideration of the CPU resources of each server node constituting a distributed processing system, the characteristic of a storage system, and the characteristic of tasks to be executed. Then, the computer programs tasks so that the number of the divided jobs is allocated in accordance with the resource amount of each node. In this way, the computer can create an environment for executing the tasks without underutilization of the resources at nodes. Alternatively, instead of programming the above execution method, a computer can use a scheduler that distributes jobs in accordance with the characteristics of the tasks so as to prevent underutilization of the resources.

However, in this environment, as a plurality of jobs are executed in parallel within a server node, the use amounts of physical resources among the jobs are difficult to be limited, causing competition on the use of the resources among the jobs, possibly leading to processing delay. Moreover, in this environment, the distributed processing system that performs the processing is not fixed. Thus, this environment requires modification of the program for each change in the structure of available nodes and in available resource amounts.

PTL 1 is a method of allocating resources to specific virtual machines, without reference to an efficient use of resources of the distributed processing system as a whole.

PTL 2 only divides tasks into CPU bound tasks and I/O bound tasks and manages the tasks accordingly. That is, PTL 2 does not refer to making the use of resources efficient in a distributed processing system, such as Hadoop, nor a measure against processing delay caused by competition on the use of the resources among the jobs.

Thus, the objective of the present invention is to solve the above-described problem, in particular, to allow an efficient use of resources in a distributed processing system, such as Hadoop, and to solve the occurrence of competition on the use of the resources among jobs, which possibly causes processing delay.

### Solution to Problem

An information processing device according to an example aspect of the invention includes:

a cluster management means that is coupled to a plurality of task execution servers that execute a task by at least one virtual machine constituting a server virtualization environment and manages cluster structure information indicating a hardware structure of the task execution servers;

a deployment means that commands the plurality of task execution servers to activate virtual machines included in each of the task execution servers based on a deployment pattern that sets the number of the virtual machines;

a job distribution means that distributes jobs to the virtual machines that are indicated by the cluster structure information and are activated on the task execution servers; and

a task execution command means that transmits a task that includes the jobs to the job distribution means, determines the deployment pattern based on supplementary information assigned to the jobs included in the task, and transmits the deployment pattern to the deployment means.

A task processing method according to an example aspect of the invention includes:

coupling to a plurality of task execution servers that execute a task by at least one virtual machine constituting a server virtualization environment and managing cluster structure information indicating a hardware structure of the task execution servers;

commanding the plurality of task execution servers to activate virtual machines included in each of the task execution servers based on a deployment pattern that sets the number of the virtual machines;

distributing jobs to the virtual machines that are indicated by the cluster structure information and are activated on the task execution servers; and

transmitting the task that includes the jobs, determining the deployment pattern based on supplementary information assigned to the jobs included in the task, and transmitting the deployment pattern.

A storage medium storing a program is provided. The program causes a computer to execute:

processing of coupling to a plurality of task execution servers that execute a task by at least one virtual machine constituting a server virtualization environment, managing cluster structure information indicating a hardware structure of the task execution servers;

processing of commanding the plurality of task execution servers to activate virtual machines included in each of the task execution servers based on a deployment pattern that sets the number of the virtual machines;

processing of distributing jobs to the virtual machines that are indicated by the cluster structure information and are activated on the task execution servers; and

processing of transmitting the task including the jobs, determining the deployment pattern based on supplementary information assigned to the jobs included in the task, and transmitting the deployment pattern.

### Advantageous Effects of Invention

In accordance with the present invention, an efficient use of resources is allowed in a distributed processing system, such as Hadoop, and such a problem as the occurrence of competition on the use of the resources among jobs, which possibly causes processing delay, is solved, thereby shortening the execution time of tasks.

### BRIEF DESCRIPTION OF DRAWINGS

FIG. 1 is a block diagram illustrating an example of the structure of an information processing system according to a first example embodiment of the present invention;

FIG. 2 is a diagram illustrating an example of a plurality of jobs constituting a task and supplementary information pertaining to each job;

FIG. 3 is a diagram illustrating definition examples of deployment patterns of virtual machines;

FIG. 4 is a diagram illustrating definition examples of corresponding patterns defined by the supplementary information of jobs constituting the task illustrated in FIG. 2 and the deployment patterns illustrated in FIG. 3;

FIG. 5 is a flowchart illustrating the operation of an information processing system;

FIG. 6 is a block diagram illustrating an example of the structure of an information processing system according to a second example embodiment; and

FIG. 7 is a block diagram illustrating an example of the structure of an information processing device according to a third example embodiment.

### DESCRIPTION OF EMBODIMENTS

### First Example Embodiment

The following will describe the details of a first example embodiment for implementing the present invention with reference to the drawings.

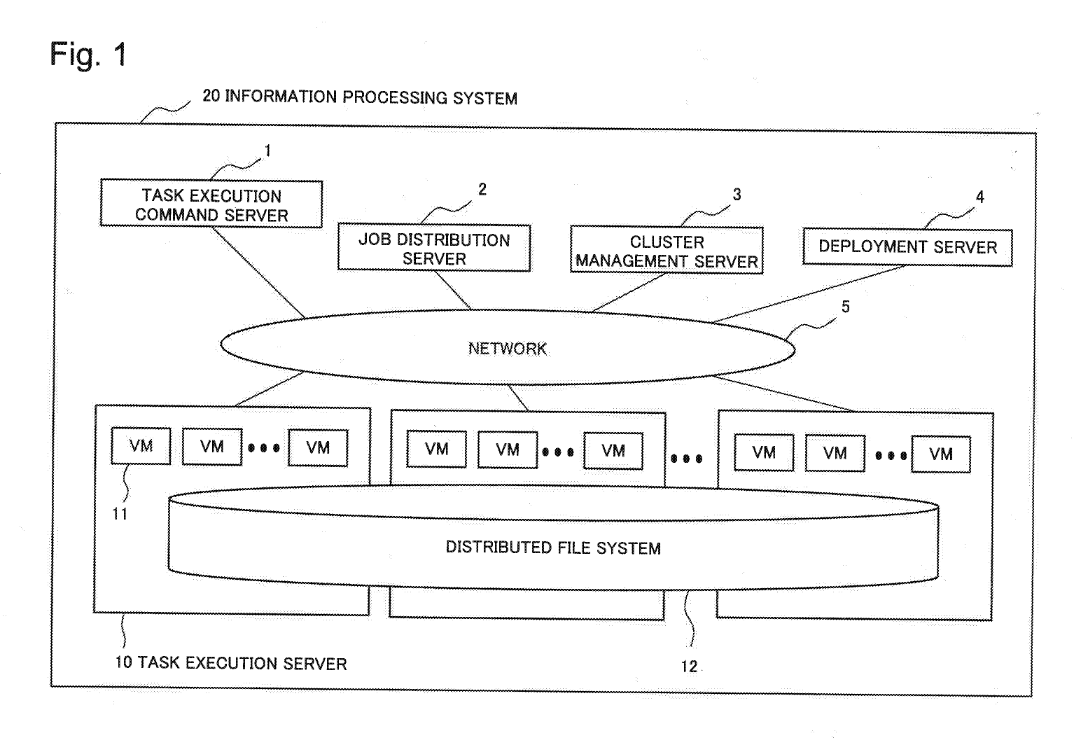

FIG. 1 is a block diagram illustrating an example of the structure of an information processing system 20 according to the first example embodiment of the present invention.

The information processing system 20 includes a task execution command server 1, a job distribution server 2, a cluster management server 3, a deployment server 4, at least two task execution servers 10, and a distributed file system 12. Each component (each server) can communicate with the respective other servers via a network 5. The task execution command server 1, job distribution server 2, cluster management server 3, and deployment server 4 are examples of information processing devices that are connected to a plurality of task execution servers 10.

Each task execution server 10 is responsible for inputting and outputting data for the distributed file system 12. Each task execution server 10 activates respective virtual machines (VM) 11 designated by the deployment server 4 based on a given condition.

The distributed file system 12 operates as a storage system formed by a combination of storage devices equipped inside the plurality of task execution servers 10. The distributed file system 12 may be configured as an external storage system where a plurality of storage mediums equipped outside the task execution servers 10 are connected via a network.

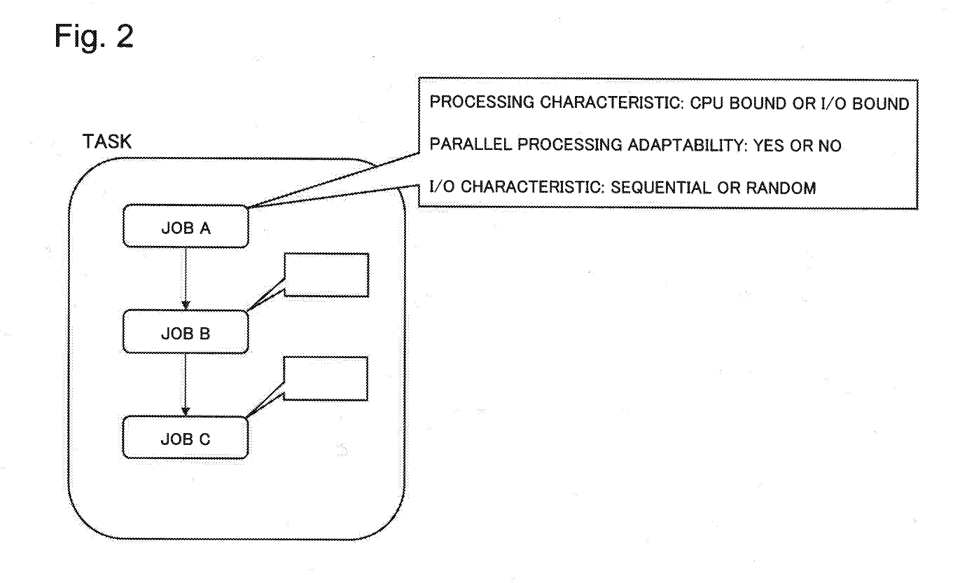

The task execution command server 1 stores supplementary information assigned to a task to be processed, as will be described later with FIG. 2, in association with jobs constituting the task. Further, the task execution command server 1 determines the number of virtual machines 11 (the number of dispositions or the number of virtual machines to be deployed) for executing the jobs constituting the task. That is, the task execution command server 1 determines the deployment pattern regarding the deployment (disposition) of virtual machines 11 in each task execution server 10. Further, the task execution command server 1 transmits the above jobs to the job distribution server 2 after completion of deployment in the task execution server 10. It should be noted that the activation of the virtual machines upon deployment is performed by the deployment server 4, as will be described later.

The job distribution server 2 distributes jobs as execution targets given by the task execution command server 1 to the plurality of virtual machines 11 (virtual machine group). Specifically, the job distribution server 2 distributes jobs to the plurality of virtual machines 11 that were activated on the task execution servers 10 configuring a cluster as a hardware group of a task processing infrastructure, based on the cluster structure information managed by the cluster management server 3. The cluster structure information is information representing a cluster.

The cluster management server 3 manages the structure information of a cluster that configures the processing infrastructure for tasks, updates the cluster structure information, and provides information in response to a query for the cluster structure information from another server.

The deployment server 4 stores the deployment patterns indicating the configuration patterns of virtual machine groups. The deployment server 4 also commands each task execution server 10 to activate the virtual machines 11 in accordance with a pattern designated by the deployment server 4 (hereinafter, referred to as the deployment pattern) based on a command from the external server group (task execution command server 1). Further, after activation of the virtual machines 11, the deployment server 4 may issue, to the cluster management server 3, an update command of the managing cluster structure information in accordance with the activated virtual machine 11 group.

The information processing system, constituted by the task execution command server 1, job distribution server 2, cluster management server 3, deployment server 4, and task execution servers 10, is configured by a single server, or each server is configured by an independent computer device. The computer device includes at least one processor that executes commands based on a program stored in a memory.

The network 5 may be configured by a wired network, a wireless network, or a network of a combination thereof.

Meanwhile, in the information processing system 20, the task execution server 10, that is, each node constituting a distributed system, embeds an execution environment of virtual machines, such as Kernel-based Virtual Machine (KVM), Xen®, and VMware®. Thus, the information processing system 20 realizes, on such an execution environment, the execution environment of parallel distribution processing, as represented by Hadoop, with each virtual machine as a unit of executing a single job.

The storage system (the distributed file system 12) connecting to the above environment is configured by a distributed file system where recording mediums on physical nodes that constitute the distributed system operate in conjunction with one another, such as a Hadoop distributed file system (HDFS) of Hadoop, or by an external storage system that allows all virtual machines to access all data as targets of analysis tasks.

In the execution environment, the deployment server 4 defines the CPU resources of nodes constituting the system and the maximum value (minimum value: one virtual machine for one node) of the number of virtual machines 11 (a virtual machine count) according to the average I/O performance. Based on these definitions, the deployment server 4 sets in advance the deployment patterns of the virtual machines 11 where resources are distributed so that early occurrence of bottleneck of the system, which might occur according to the characteristics of the tasks to be executed, is prevented. It is assumed that the deployment server 4 sets the CPU resources to be used and the maximum issuance number of I/O per unit time for each virtual machine 11 to limit the use of the physical resources.

The task execution command server 1 of the example embodiment assigns various conditions, such as the adequacy of parallel execution, I/O or CPU dependency, and data volume of each job, as supplementary information to the inside of a task to be executed based on the deployment pattern of the virtual machines 11 according to the above-described definitions. The task execution command server 1 includes means for distributing and executing jobs in units of virtual machines by changing the number of virtual machines to be deployed (dispositioned) for executing jobs, instead of, for example, changing the method of distributing the jobs by a task scheduler of the task execution command server 1.

Further, the task execution command server 1 may include the following determination unit. The determination unit assumes, for example, cases where a task is constituted by a plurality of jobs having a plurality of steps. Next, the determination unit compares execution time of a job to be executed and time for reconstruction of the virtual machines 11 (from the shutdown of the virtual machines until deployment of the virtual machine environment optimal for execution of a next job). The determination unit performs the reconstruction of the virtual machines 11 only when the reconstruction time of the virtual machines 11 is sufficiently shorter than the execution time of the next job as a result of the comparison.

If the structure of the physical nodes constituting a distributed system is changed, the information processing system 20 changes only the deployment pattern of the virtual machines 11 without changing the tasks to be executed.

FIG. 2 is a diagram illustrating an example of a plurality of jobs constituting a task and supplementary information pertaining to each job.

Each job constituting a task is assigned with at least three pieces of supplementary information: a processing characteristic; parallel processing adaptability; and an I/O characteristic.

The processing characteristic is supplementary information indicating whether CPU processing time is dominant in relation to the total processing time of jobs (CPU bound: CPU dependent) or I/O processing time is dominant in relation to the total processing time of jobs (I/O bound: I/O dependent).

The parallel processing adaptability is supplementary information indicating whether or not the programmed job supports (is adapted to) multiprocessing and multithreading (Yes or No).

The I/O characteristic is supplementary information indicating how to read data as a processing target of a job (Sequential or Random: sequential reading or random reading).

The supplementary information is given and stored in advance by a user who is managing the task execution command server 1, to which tasks are supplied. However, if the job characteristic cannot be determined in advance, the task execution command server 1 may assign information later as necessary based on an operation by a user.

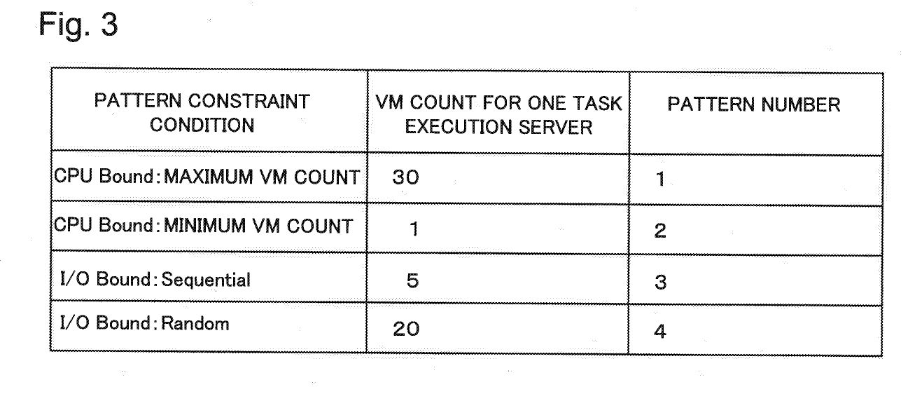

FIG. 3 is a diagram illustrating definition examples of the deployment patterns of virtual machines 11 when a cluster system constituted by a plurality of task execution servers 10 is assumed. These definition examples are defined (set) into the deployment server 4.

Each deployment pattern is constituted by three pieces of information: a pattern constraint condition; the number of virtual machines (a VM count) for one task execution server 10; and a pattern number for identifying each pattern.

The pattern constraint condition of each deployment pattern is defined in accordance with a processing characteristic included in the supplementary information of a job. The deployment server 4 sets the maximum value and minimum value of the number of virtual machines in the case of CPU bound. The deployment server 4 further sets the number of virtual machines that maximizes Sequential READ (sequential reading) performance and the number of virtual machines that maximizes Random READ (random reading) performance in the case of I/O bound.

The maximum value of the number of virtual machines in the case of CPU bound is set as a value corresponding to the number of logic core, the number of physical core, and the number of logic threads of a CPU, for example, based on the characteristic of the CPU that can be used by a virtualization infrastructure that operates on the task execution servers 10.

Further, the minimum value of the number of virtual machines in the case of CPU bound is one virtual machine 11 (the VM count is one) for one task execution server 10.

For example, if the job execution program is a processing program that is adaptable to only one parallel processing stream is processed by a CPU, of which number of cores is 30, the VM count is 30. If a processing program that is adaptable to up to 30 parallel processing streams is processed by a CPU, of which number of cores is 30, the VM count is one. The VM counts derived in this way are set, for example, as the maximum value and the minimum value as described above.

These pattern definition values are based on the specification information of the task execution servers 10, the specification information of the distributed file system 12, or the performance specification information of the system that has been previously measured. The pattern definition values are set in advance, for example, in the deployment server 4 or the task execution command server 1 by an operation administrator of the system.

If task execution servers 10 with different specifications are mixed, the operation administrator of the system defines a deployment pattern for each virtual machine 11 with a different specification in the deployment server 4.

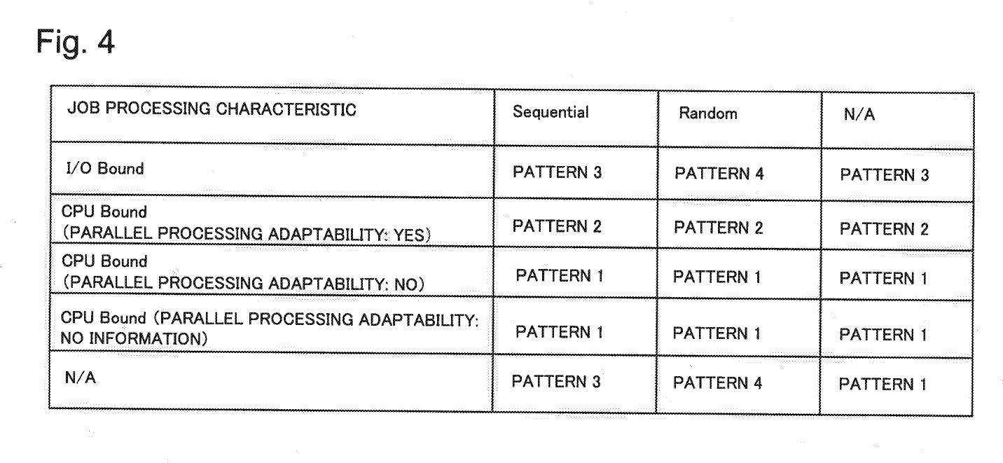

FIG. 4 is a diagram illustrating definition examples of corresponding patterns that are defined based on supplementary information of jobs assigned as illustrated in FIG. 2 and the deployment patterns (pattern numbers) defined as illustrated in FIG. 3.

If the job processing characteristic is I/O bound, the pattern is determined depending on whether the I/O characteristic is Sequential (sequential reading) or Random (random reading).

If the job processing characteristic is CPU bound, parallel processing adaptability is determined depending on whether the programmed job supports either multiprocessing or multithreading execution and, then, the pattern is determined.

Even in cases where supplementary information of a job processing characteristic is assigned, yet, supplementary information of either parallel processing adaptability or an I/O characteristic is not assigned (like when the “job processing characteristic” is “N/A (Not Applicable)” as illustrated in FIG. 4), the priority of assigned information is set in the order of, for example, 1. processing characteristic, 2. I/O characteristic, 3. parallel processing adaptability. In this way, a matching pattern is selected from among the assigned information.

For the above priority, the priority order can be changed in accordance with the performance of the CPU and the performance of the storage medium that constitute the task execution server 10. For example, if a semiconductor device, such as Solid State Drive (SSD), is used as a storage medium of the task execution server 10, as the dependency on the I/O characteristic is reduced, a priority order definition such as prioritizing parallel processing adaptability can be considered.

The definition examples of the corresponding patterns illustrated in FIG. 4 can be stored and managed by the task execution command server 1.

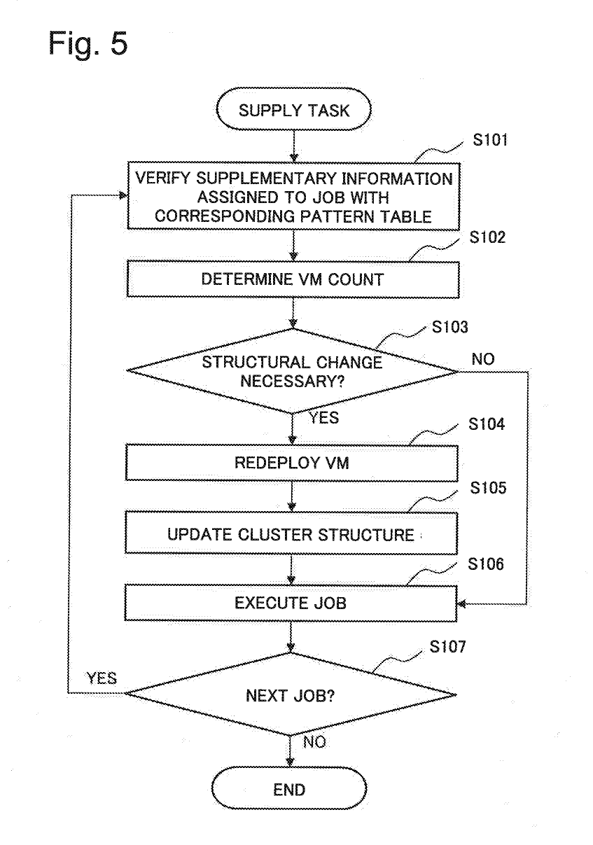

FIG. 5 is a flowchart illustrating the operation of an information processing system 20.

With reference to the flowchart illustrated in FIG. 5, the following will describe the execution procedure of a task supplied to the task execution command server 1 based on the supplementary information assigned to the task illustrated in FIG. 2 and the pattern definitions corresponding to the supplementary information as illustrated in FIGS. 3 and 4.

First, a task is supplied to the task execution command server 1 by a user who desires to execute the task.

The task execution command server 1 decomposes the task into jobs included in the task, further refers to the supplementary information assigned to the jobs, and verifies the supplementary information with a correspondence pattern table represented in an example illustrated in FIG. 4 (step S101). Then, the task execution command server 1 extracts a deployment pattern of virtual machines for execution of the jobs from the deployment server 4. Next, the task execution command server 1 refers to the definition examples illustrated in FIG. 3 from the extracted deployment pattern and determines the number of virtual machines to be deployed corresponding to the pattern number (step S102).

Next, the task execution command server 1 queries and acquires the cluster structure information from the cluster management server 3, as well as, the deployment state of the virtual machines from the deployment server 4. The task execution command server 1 further extracts the number of virtual machines that has been already determined at step S102 and the number of virtual machines that have been already deployed from the deployment state, compares the both, and checks if there is a difference. According to the difference, the task execution command server 1 determines whether the structural change of the virtual machines 11 is necessary (step S103).

If the structural change of the virtual machines 11 is not necessary (No at S103), the task execution command server 1 transmits jobs constituting a task as execution targets to the job distribution server 2 and waits until the processing completes. The job distribution server 2 queries the cluster management server 3 about cluster structure information, distributes the jobs to the virtual machine 11 group constituting the cluster, and waits until all the processing of jobs completes (step S106).

If the structural change of the virtual machines 11 is necessary (Yes at S103), the task execution command server 1 commands the deployment server 4 to deploy (dispose) virtual machines 11 with the virtual machine count that has been determined at step S102 as described above.

In response to the command, the deployment server 4 shuts down existing virtual machines 11 operating on the task execution servers 10 and deploys (redeploys) the designated number of virtual machines 11 to the task execution server 10 (step S104).

After completing the deployment, the deployment server 4 notifies the task execution command server 1 that the deployment of the designated virtual machines 11 has completed.

After receiving the above completion notification, the task execution command server 1 executes a command of changing the cluster structure information to the cluster management server 3, based on the deployed virtual machine structure (step S105).

After the cluster management server 3 completes the change of the cluster structure information, the task execution command server 1 transmits the jobs constituting the above-described task as execution targets to the job distribution server 2 and waits until all the processing completes as described with the above S106.

At S106, after completion of all the processing in the virtual machines 11, to which the jobs have been distributed, the job distribution server 2 notifies the task execution command server 1 that the execution of the jobs has completed.

The task execution command server 1 determines whether a next job exists (step S107), and, if there is a next job, returns to S101 and continues the execution of the task. On the other hand, if there is no next job, the task execution command server 1 completes the execution of the task.

There are cases where redeployment of the virtual machines 11 is necessary as an operation method of S104. In such cases, if the job processing characteristic is I/O bound and the total data volume as the processing target can be acquired by querying the distributed file system 12, the task execution command server 1 calculates the total I/O time according to the I/O pattern.

Moreover, if the job processing characteristic is CPU bound and the total amount of data as a processing target can be acquired by querying the distributed file system 12, the task execution command server 1 experimentally measures the processing time as a guide of time to be taken for one piece of data in the existing cluster environment and calculates the total processing time.

Then, the task execution command server 1 may execute redeployment of the virtual machines 11 only when the sum of the shutdown time of the virtual machines 11 and the deployment time of the virtual machines 11 is sufficiently shorter compared with each calculated time.

There are cases also where the information processing system 20 may be in an environment where the structure of physical nodes, such as server nodes, constituting a distributed processing system vary or an environment where physical nodes having different specifications are combined. Even in such cases, the information processing system 20 changes only the pattern definition (FIG. 3) for deploying the virtual machines 11, then, after deploying the virtual machine count according to the characteristic of a task, distributes the jobs via a parallel distribution processing infrastructure, such as Hadoop. In this way, the execution time of the task can be shortened without changing the program for executing the task.

The information processing system 20 according to the first example embodiment provides an effect as described below.

According to the first example embodiment, in a distributed processing system, such as Hadoop, resources can be efficiently used without underutilization. Further, the system can allocate the number of divided jobs in accordance with the resource amount of each node, whereby competition on the use of the resources among the jobs does not occur and processing delay can be suppressed.

This is because each job within a task to be executed is assigned with various conditions, such as a processing characteristic, parallel processing adaptability, and an I/O characteristic, as supplementary information, and a deployment pattern for setting the number of virtual machines 11 is determined based on the supplementary information that has been set in advance. Another reason is that the number of virtual machines 11 to be deployed for executing jobs can be changed based on the deployment pattern according to the characteristic of the task. That is, jobs can be distributed and executed in units of virtual machines, thereby, allowing to shorten the execution time of the task.

### Second Example Embodiment

The following will describe the details of a second example embodiment for implementing the present invention with reference to the drawings.

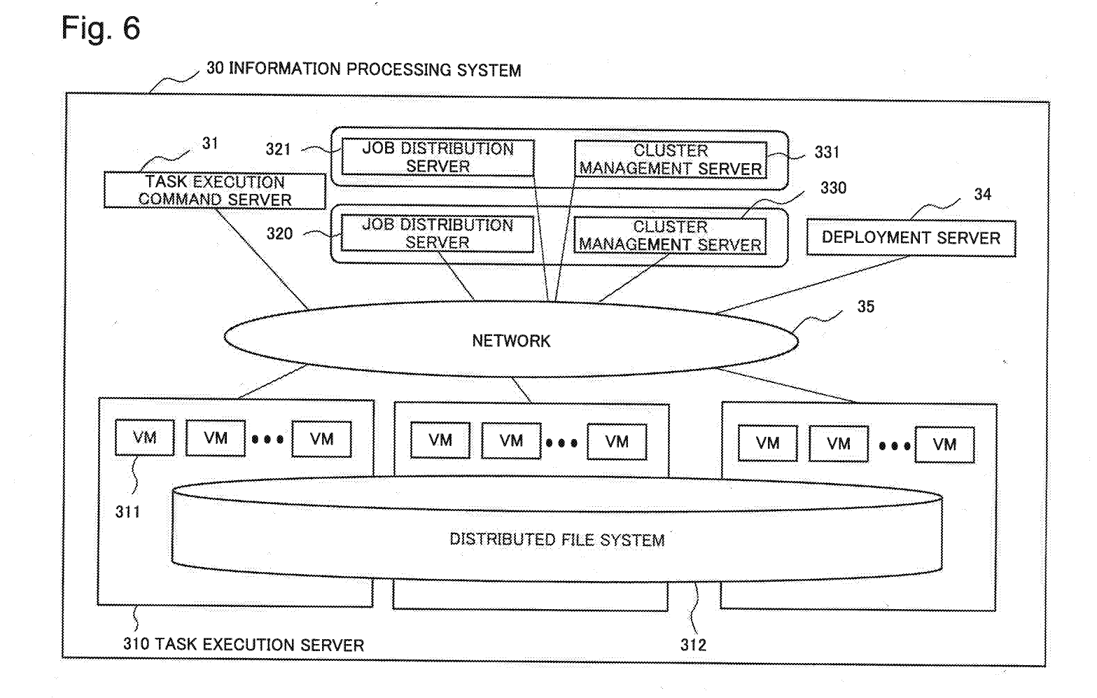

FIG. 6 is a block diagram illustrating an example of the structure of an information processing system 30 according to the second example embodiment.

The information processing system 30 has the same structure as the information processing system 20 of the first example embodiment illustrated in FIG. 1. However, the information processing system 30 has a structure where a plurality of pairs of job distribution servers 320, 321 and cluster management servers 330, 331 connect to the network 35 and share the task execution command server 31, deployment server 34, and task execution server 310 group. It should be noted that, while FIG. 6 illustrates a case where there are two of the above pairs, the number of pairs may be an arbitrary number of two or more.

In the information processing system 30, each pair of the job distribution server 320 and cluster management server 330 and the job distribution server 321 and cluster management server 331 executes tasks with different characteristics in parallel. The information processing system 30 has determined in advance the resource use ratio of the task execution server 310 group that each pair uses. Then, on the premise of the resource ratio to be used by each pair, the information processing system 30 defines a deployment pattern of the virtual machines 311 corresponding to the above each pair (equivalent to FIG. 3 of the first example embodiment) and a pattern corresponding to a job characteristic (equivalent to FIG. 4 of the first example embodiment). As such, a mixture of a plurality of tasks with different characteristics can be executed in parallel.

As described above, the information processing system 30 can attain an effect of shortened processing time of tasks within ranges of predetermined resource use ratios without causing competition on the resources among the tasks.

The information processing system 30 according to the second example embodiment provides an effect as described below.

The effect can be attained when each pair of the job distribution server 320 and cluster management server 330 and the job distribution server 321 and cluster management server 331 executes tasks with different characteristics in parallel. As described above, processing time of tasks can be shortened within ranges of predetermined resource use ratios without causing competition on the resources among the tasks.

This is because the information processing system 30 determines in advance the resource use ratio of the task execution server 310 group which is used by each pair of the job distribution server 320 and cluster management server 330 and the job distribution server 321 and cluster management server 331. Then, on the premise of the resource ratio used by each pair, the information processing system 30 defines a deployment pattern of the virtual machines corresponding to each pair and a pattern corresponding to the job characteristic.

### Third Example Embodiment

The following will describe the details of a third example embodiment for implementing the present invention with reference to the drawings.

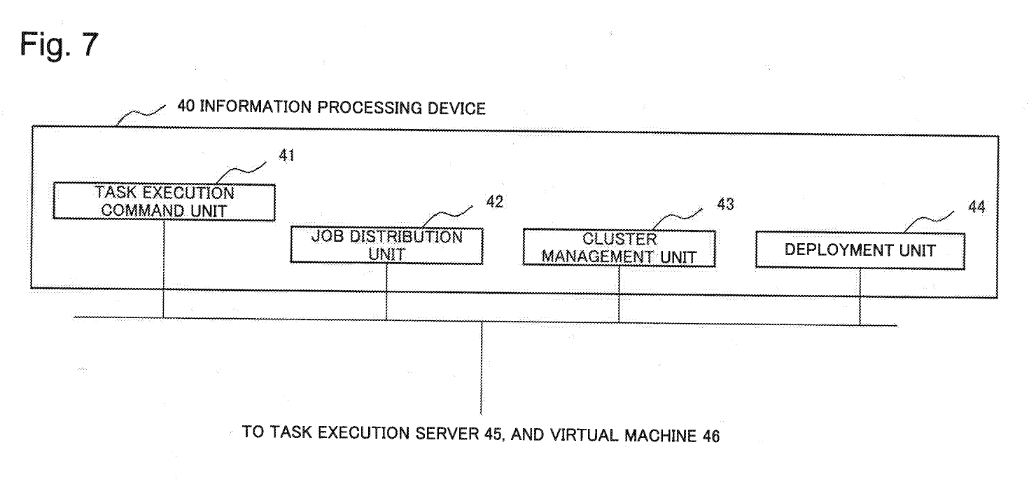

FIG. 7 is a block diagram illustrating an example of the structure of an information processing device 40 according to the third example embodiment.

The information processing device 40 includes a task execution command unit 41, a job distribution unit 42, a cluster management unit 43, and a deployment unit 44. The task execution command unit 41, job distribution unit 42, cluster management unit 43, and deployment unit 44, are connected with task execution servers 45 via an internal bus in the information processing device 40 or a network.

The information processing device 40 is connected to a plurality of task execution servers 45 that execute tasks using at least one virtual machine constituting a server virtualization environment. Then, the information processing device 40 includes the cluster management unit 43, deployment unit 44, job distribution unit 42, and task execution command unit 41. The cluster management unit 43 manages cluster structure information indicating the hardware structure of the task execution servers 45. The deployment unit 44 commands the plurality of task execution servers 45 to activate virtual machines 46 based on a deployment pattern that sets the number of the virtual machines 46 to be included in each task execution server 45. The job distribution unit 42 distributes jobs to the virtual machines 46 that are indicated by the cluster structure information and are activated on the task execution servers 45. The task execution command unit 41 transmits a task including jobs to the job distribution unit 42, determines a deployment pattern based on supplementary information assigned to the jobs included in the task, and transmits the deployment pattern to the deployment unit 44.

The information processing device 40 according to the third example embodiment provides an effect as described below.

According to the third example embodiment, in a distributed processing system, such as Hadoop, resources can be used efficiently without underutilization. Further, the system can allocate the number of divided jobs in accordance with the resource amount of each node, whereby competition on the use of resources among the jobs does not occur and processing delay can be suppressed.

This is because the deployment pattern indicating the number of virtual machines 46 is determined based on the supplementary information assigned to the jobs included in the task and the deployment pattern is used to command activation of the virtual machines 46.

As above, the present invention has been described with the above-described example embodiments as model examples. However, the present invention is not limited to the above-described example embodiments. That is, the present invention can be applied to a variety of modes that can be understood by those skilled in the art within the scope of the present invention.

This application claims priority based on Japanese Patent Application No. 2014-252130 filed on Dec. 12, 2014, which application is incorporated herein in its entirety by disclosure.

### REFERENCE SIGNS LIST

1 Task execution command server
2 Job distribution server
3 Cluster management server
4 Deployment server
5 Network
10 Task execution server
11 Virtual machine (VM)
12 Distributed file system
20 Information processing system
30 Information processing system
31 Task execution command server
310 Task execution server
311 Virtual machine
312 Distributed file system
320, 321 Job distribution server
330, 331 Cluster management server
34 Deployment server
35 Network
40 Information processing device
41 Task execution command unit
42 Job distribution unit
43 Cluster management unit
44 Deployment unit
45 Task execution server
46 Virtual machine

What is claimed is:

1. An information processing device comprising:
a cluster management server that is coupled to a plurality of task execution servers that execute a task by at least one virtual machine constituting a server virtualization environment and manages cluster structure information indicating a hardware structure of the task execution servers;
a deployment server that commands the plurality of task execution servers to activate virtual machines included in each of the task execution servers based on a deployment pattern that sets the number of the virtual machines;
a job distribution server that distributes jobs to the virtual machines that are indicated by the cluster structure information and are activated on the task execution servers; and
a task execution command server that transmits a task that includes the jobs to the job distribution means, determines the deployment pattern based on supplementary information assigned to the jobs included in the task, and transmits the deployment pattern to the deployment means.

2. The information processing device according to claim 1, wherein the supplementary information includes a processing characteristic indicating central processing unit (CPU) dependent or input/output (I/O) dependent.

3. The information processing device according to claim 1, wherein the supplementary information includes parallel processing adaptability indicating whether or not a job is adapted to multiprocessing or multithreading.

4. The information processing device according to claim 1, wherein the supplementary information includes an I/O characteristic indicating sequential or random.

5. The information processing device according to claim 1, wherein there is a plurality of pairs of the job distribution server and the cluster management server, and
the task execution command server determines the deployment pattern for each of the pairs based on a resource ratio used by each of the pairs.

6. An information processing system comprising:
the information processing device according to claim 1; and
a plurality of task execution servers coupled to the information processing device.

7. A task processing method comprising:
coupling to a plurality of task execution servers that execute a task by at least one virtual machine constituting a server virtualization environment and managing cluster structure information indicating a hardware structure of the task execution servers;
commanding the plurality of task execution servers to activate virtual machines included in each of the task execution servers based on a deployment pattern that sets the number of the virtual machines;
distributing jobs to the virtual machines that are indicated by the cluster structure information and are activated on the task execution servers; and
transmitting the task that includes the jobs, determining the deployment pattern based on supplementary information assigned to the jobs included in the task, and transmitting the deployment pattern.

8. The task processing method according to claim 7, wherein the supplementary information includes a processing characteristic indicating CPU dependent or I/O dependent.

9. The task processing method according to claim 7, wherein the supplementary information includes parallel processing adaptability indicating whether or not a job is adapted to multiprocessing or multithreading.

10. A storage medium storing a program that causes a computer to execute:
coupling to a plurality of task execution servers that execute a task by at least one virtual machine constituting a server virtualization environment, managing cluster structure information indicating a hardware structure of the task execution servers;
commanding the plurality of task execution servers to activate virtual machines included in each of the task execution servers based on a deployment pattern that sets the number of the virtual machines;
distributing jobs to the virtual machines that are indicated by the cluster structure information and are activated on the task execution servers; and
transmitting the task including the jobs, determining the deployment pattern based on supplementary information assigned to the jobs included in the task, and transmitting the deployment pattern.
